(19) United States
(12) Patent Application Publication
(10) Pub. No.: US 2020/0358579 A1
(43) Pub. Date: Nov. 12, 2020

(54) METHOD, APPARATUS, AND SYSTEM FOR CONFIGURING REFERENCE SIGNAL

(71) Applicant: HUAWEI TECHNOLOGIES CO., LTD., Shenzhen (CN)

(72) Inventors: Fengwei LIU, Chengdu (CN); Lei CHEN, Shenzhen (CN); Jing QIU, Chengdu (CN); Xiaoyong TANG, Shenzhen (CN)

(21) Appl. No.: 16/939,901

(22) Filed: Jul. 27, 2020

Related U.S. Application Data
(63) Continuation of application No. PCT/CN2019/073747, filed on Jan. 29, 2019.

(30) Foreign Application Priority Data
Feb. 9, 2018 (CN) 201810135167.7

(51) Int. Cl. H04L 5/00; H04B 7/155

(52) U.S. Cl. CPC H04L 5/0057; H04B 7/155; H04L 5/0023

(57) ABSTRACT

Example methods and apparatus for configuring a reference signal are provided. One example method includes determining first information including beam information of beams used by a link between the second node and a third node by a. first node. The first node serves as an upper-level node of a second node. The first node sends configuration information to the second node to indicate a reference signal received or sent by the second node on a target beam. The target beam is at least one of the beams used by the link between the second node and the third node, so that the first node can indicate the second node to receive or send the reference signal based on the beams used by the link between the second node and the third node. The second node may further measure interference between the backhaul links based on the reference signal.

### CROSS-REFERENCE TO RELATED APPLICATIONS

This application is a continuation of International Application No. PCT/CN2019/073747, filed on Jan. 29, 2019, which claims priority to Chinese Patent Application No. 201810135167.7, filed on Feb. 9, 2018. The disclosures of the aforementioned applications are hereby incorporated by reference in their entireties.

### TECHNICAL FIELD

This application relates to the field of communications technologies, and in particular, to a method, an apparatus, and a system for configuring a reference signal.

### BACKGROUND

Currently, to improve communication reliability and quality in a communications system, a base station measures inter-cell interference by configuring a zero power CSI-RS (ZP-CSI-RS, channel state information-reference signal, CSI-RS) for user equipment (UE). Alternatively, the base station measures interference in a cell or in a base station coordination cluster by configuring a non-zero power CSI-RS (NZP-CSI-RS) for the UE.

Backhaul links are introduced in a new radio (NR) communications system, and there is mutual interference between the backhaul links. Specifically, a backhaul link is a link between relay nodes. However, a manner for configuring a signal, for example, a ZP-CSI-RS or an NZP-CSI-RS, used for interference measurement in the prior art cannot be applied to a scenario in which a relay node measures signal interference between the backhaul links.

In conclusion, the manner for configuring the signal, for example, the ZP-CSI-RS or the NZP-CSI-RS, used for the interference measurement in the prior art cannot be applied to the scenario in which the relay node measures the signal interference between the backhaul links.

### SUMMARY

This application provides a method, an apparatus, and a system for configuring a reference signal, to resolve a technical problem in the prior art that signal interference between backhaul links cannot be measured.

According to a first aspect, an embodiment of this application provides a method for configuring a reference signal, and the method includes: determining, by a first node, first information, where the first information may include beam information of beams used by a link between a second node and a third node; and then sending, by the first node, configuration information to the second node, to indicate the second node to send a reference signal to the third node on a target beam, where the target beam is at least one of the beams used by the link between the second node and the third node. According to the method, the first node can configure the second node. The reference signal between the second node and the third node is received or sent, and interference measurement on a backhaul link between the second node and the third node can be performed based on the reference signal that is sent by the third node and that is received by the second node, or based on the reference signal sent by the second node to the third node.

In a possible design, if the beams used by the link between the second node and the third node are transmit beams used by the second node to send information to the third node, after determining the first information, the first node knows the transmit beams used by the second node to send the information to the third node, may further determine at least one target beam from the transmit beams, and then sends the configuration information to the second node, to indicate the second node to send the reference signal by using the target beam. Alternatively, if the beams used by the link between the second node and the third node are receive beams used by the second node to receive information sent by the third node, after determining the first information, the first node knows the receive beams used by the second node to receive the information sent by the third node, may further determine at least one target beam from the receive beams, and then sends the configuration information to the second node, to indicate the second node to receive the reference signal by using the target beam. The reference signal received by the second node may be from a fourth node, and the fourth node may be the same as the first node or the third node, or may be another node in a network.

In a possible design, the beam information of the beams used by the link between the second node and the third node may be at least one piece of the following information: a beam number, an identifier of a sending node of one of the beams, an identifier of a receiving node of one of the beams, a beam index, or a quantity of the beams used by the link between the second node and the third node. The foregoing beam information can be used to identify the beams used by the link between the second node and the third node.

In a possible design, the first information may further include information about a reference signal of at least one beam between the second node and the third node, and the information about the reference signal may be an identifier and/or configuration information of the reference signal. Therefore, the first information further indicates the reference signal of the at least one beam between the second node and the third node. After determining the first information, the first node can indicate, by using the configuration information, the second node to receive or send, by using the target beam, a reference signal that has a quasi co-location (QCL) relationship with the reference signal indicated in the first information, so that a beam of the reference signal is implicitly indicated based on a configured reference signal.

In a possible design, the first information may be reported by the second node to the first node, or the first information may be pre-configured on the first node.

According to a second aspect, an embodiment of this application further provides a first node for configuring a reference signal. The first node may include a transceiver, a memory, and a processor, where the transceiver is used by the first node to perform communication, the memory is configured to store code, and the processor is configured to: execute the code stored in the memory, and perform the method for configuring the reference signal according to the foregoing first aspect.

According to a third aspect, an embodiment of this application further provides a second node for configuring a reference signal. The second node may include a transceiver, a memory, and a processor, where the transceiver is used by the second node to perform communication, the memory is configured to store code, and the processor is configured to: execute the code stored in the memory, and perform the method for configuring the reference signal according to the foregoing first aspect.

According to a fourth aspect, an embodiment of this application further provides a computer-readable storage medium, where the computer-readable storage medium stores code; and when the code is invoked and executed by a computer, the computer may be enabled to complete the method for configuring the reference signal related to the first node or the second node in the foregoing method embodiments or any one of possible implementations of the method embodiments.

According to a fifth aspect, this application further provides a computer program product. When the computer program product is invoked and executed by a computer, the computer may be enabled to complete the method related to the first node or the second node in the foregoing first aspect or any one of possible designs of the first aspect.

According to a sixth aspect, this application further provides a chip. The chip may be coupled to the transceiver in the foregoing second aspect, and is configured to implement the method for configuring the reference signal and that can be implemented by the first node in the foregoing second aspect, or the chip may be coupled to the transceiver in the third aspect, and is configured to implement the method for configuring the reference signal and that can be implemented by the second node in the foregoing third aspect.

According to a seventh aspect, an embodiment of this application further provides a system for configuring a reference signal. The system includes the first node provided in the second aspect and the second node provided in the third aspect.

### DESCRIPTION OF DRAWINGS

FIG. 1 is a schematic architectural diagram of a communications system to which a method for configuring a reference signal is applicable according to an embodiment of this application;

FIG. 2 is a schematic logic structural diagram of a first node for configuring a reference signal according to an embodiment of this application;

FIG. 3 is a schematic logic structural diagram of a second node for configuring a reference signal according to an embodiment of this application;

FIG. 4 is a schematic diagram of steps of a method for configuring a reference signal according to an embodiment of this application;

FIG. 5 is a schematic diagram of node distribution of a method for configuring a reference signal according to an embodiment of this application;

FIG. 6 is a schematic diagram of distribution of beams between a second node and a third node according to an embodiment of this application;

FIG. 7 is a schematic structural diagram of a system for configuring a reference signal according to an embodiment of this application;

FIG. 8 is a schematic structural diagram of a first node for configuring a reference signal according to an embodiment of this application; and

FIG. 9 is a schematic structural diagram of a second node for configuring a reference signal according to an embodiment of this application.

### DESCRIPTION OF EMBODIMENTS

To resolve a technical problem in the prior art that signal interference between backhaul links cannot be measured, embodiments of this application provide a method, an apparatus, and a system for configuring a reference signal. The method includes: determining, by a first node that serves as an upper-level node of a second node, first information, where the first information may include beam information of beams used by a link between the second node and a third node; and then sending, by the first node, configuration information to the second node, to indicate a reference signal received or sent by the second node on a target beam, where the target beam is at least one of the beams used by the link between the second node and the third node, so that the first node can indicate the second node to receive or send the reference signal based on the beams used by the link between the second node and the third node, so that interference caused by the link between the second node and the third node to another link or interference caused by another link to the link between the second node and the third node may further be measured.

The following explains some terms in this application.

The first node, the second node, and the third node may be communications nodes in a communications system. For example, the first node may be a base station or a relay node in a relay communications system, and the second node and the third node may be relay nodes in the relay communications system, where the third node may further be UE accessing the relay communications system. In the embodiments of this application, the first node may be a node that provides a service for another node in the communications system, for example, may be a node that provides a service for the second node, that is, the upper-level node of the second node. In addition, the communications system in which the first node, the second node, and the third node are located may further include a fourth node. In an implementation, the fourth node may be the base station or the relay node in the relay communications system. The second node receives, on the target beam based on the configuration information sent by the first node, a reference signal sent by the fourth node. The first node may indicate, based on the beam information of the beams used by the link between the second node and the third node, the second node to receive, on the target beam, the reference signal sent by the fourth node, while the reference signal sent by the fourth node may be sent by the fourth node configured by the first node or another node.

The link between nodes may be a wireless transmission link, that is, a path for transmitting information between the nodes by using a beam resource. Specifically, in the embodiments of this application, the second node and the third node may be relay nodes in the relay communications system, and the link between the second node and the third node may be a backhaul link in the relay communications system. In the embodiments of this application, the link between the nodes may alternatively be a link that has only a measurement function. For example, the link between the second node and the third node may be a link on which the second node sends a measurement signal and the third node measures interference.

A beam is a communication resource. The beam in the embodiments of this application may be a wide beam, a narrow beam, or a beam of another type. A technology for forming a beam may be a beam forming technology or another technical means. Specifically, the beam forming technology may be specifically a digital beam forming technology, an analog beam forming technology, or a hybrid digital or analog beam forming technology. Different beams may be considered as different communication resources, and same information or different information may be sent by using different beams. A plurality of beams that have same or similar communication features may be considered as one beam. One beam may include one or more antenna ports, configured to transmit data channels, control channels, and sounding signals. For example, a transmit beam may be distribution of signal strength formed in different spatial directions after a signal is transmitted by using an antenna, and a receive beam may be distribution of signal strength that is formed in different spatial directions and that is of a radio signal received from the antenna. It may be understood that, the one or more antenna ports forming one beam may also be considered as an antenna port set. In addition, the beam may be indicated by using information about the signal (which may be a configured reference signal, or the like). The information about the signal may be an identifier, an antenna port number, an index number, and the like of the signal, for example, an identifier of a reference signal, for example, an identifier and/or an antenna port number of a CSI-RS, an index number and/or an identifier of a synchronization signal (SS)/physical broadcast channel (PBCH) block, an identifier and/or an antenna port number of a sounding signal (SRS), an identifier of a tracking signal (TRS).

The transmit beam is a beam used when a sending node sends information to a receiving node in a wireless communications network, where the sending node is a node that sends the information, and the receiving node is a node that receives the information.

The receive beam is a beam used when the receiving node receives the information sent by the sending node in the wireless communications network.

The reference signal may be a reference signal configured by the base station for the user equipment or the relay device in the wireless communications system, to enable the user equipment or another relay device within a coverage area of the base station to measure a downlink or uplink channel state. The user equipment or the relay device performs downlink or uplink channel estimation based on the reference signal. In implementation, the reference signal may be the CSI-RS, the SRS, or the like.

The configuration information may be configuration information of the reference signal sent by the base station to the user equipment or the relay device in the wireless communications system, and the configuration information may indicate the device to receive or send the reference signal. The configuration information includes information about the reference signal configured by the base station, for example, a quantity of antenna ports and number information that are used to receive or send the reference signal, a time-frequency resource occupied by the reference signal, or a time domain feature (periodic, semi-persistent, or aperiodic) of the reference signal. In addition, in implementation, the configuration information may be used to indicate the communications node to transmit the beam or receive the beam, and may be further used to indicate beam information of the beam used by the communications node to send or receive the reference signal, for example, used to indicate a beam number, or a reference signal that has a QCL (QCL) relationship with the reference signal. In addition, the configuration information of the reference signal may further include information such as sequence information of the reference signal or the sending node of the reference signal. The beam information of the beam is information used to describe the beam. For example, the beam information may include at least one piece of the following information: sending node information of the beam, receiving node information of the beam, a beam index, and a beam number. A beam may be uniquely identified by using the beam information. The beam number may be a number of the transmit beam or the receive beam numbered by the node to which the beam belongs. For example, the base station numbers all transmit beams of the base station, so that information about the beam number can be used to uniquely identify a transmit beam. The beam index may be a number of a beam that is of another node and that is numbered by the node in the wireless communications system. For example, the base station in the wireless communications system separately numbers transmit beams and receive beams that are managed by all lower-level nodes within the coverage area of the base station, so that the transmit beams and the receive beams of all lower-level nodes of the base station within the coverage area of the base station can be uniquely identified based on the beam index.

The backhaul link is a link formed between an upper-level node (for example, the base station or the relay node) and a device that has a relay function, or between a device that has a relay function and another device that has the relay function in the relay network system. A concept relative to the backhaul link is an access link, and the access link is a link between a master node and UE accessing the master node, or the access link is a link between the device that has the relay function and UE accessing the device.

That there is a QCL relationship between two reference signals means that there is a QCL relationship between antenna port numbers of the two reference signals. That there is a QCL relationship between two antenna ports means that large-scale properties of a channel over which a symbol on one antenna port is conveyed may be inferred from large-scale properties of a channel over which a symbol on the other antenna port is conveyed. The large-scale properties of the channel include one or more of the following properties: a delay spread, a Doppler spread, a Doppler shift, an average gain, an average delay, and a spatial reception parameter. Both a reference signal of an NR and a reference signal of LTE carry the antenna port numbers. Therefore, the QCL relationship is usually established between reference signals. For example, the base station may configure one reference signal for the UE, and indicate that the reference signal has a QCL relationship of a type with the other reference signal, to assist the UE in determining a reception parameter or an emission parameter.

In the prior art, a beam indication may be implicit indication based on the QCL relationship between the reference signals. A method for indicating the receive beam by using the QCL relationship between the reference signals is as follows: When the UE is configured to receive a reference signal A, the reference signal A and a reference signal B may be configured to have a spatial QCL relationship. Usually, the reference signal B is a signal known to one UE (for example, sent by the base station). Therefore, the UE may receive the reference signal A by using a beam for receiving the reference signal B. A method for indicating the transmit beam by using the QCL relationship between the reference signals is as follows: When the UE is configured to send a reference signal A, the reference signal A and a reference signal B may be configured to have a spatial QCL relationship. For a transmit beam indication, there are two cases for the reference signal B. First, the reference signal B is a signal known to one UE (sent by the base station). Therefore, the UE may send the reference signal A by using the beam for receiving the reference signal B. Second, the reference signal B is another transmit signal of the UE. Therefore, the UE may send the reference signal A by using a beam for sending the reference signal B.

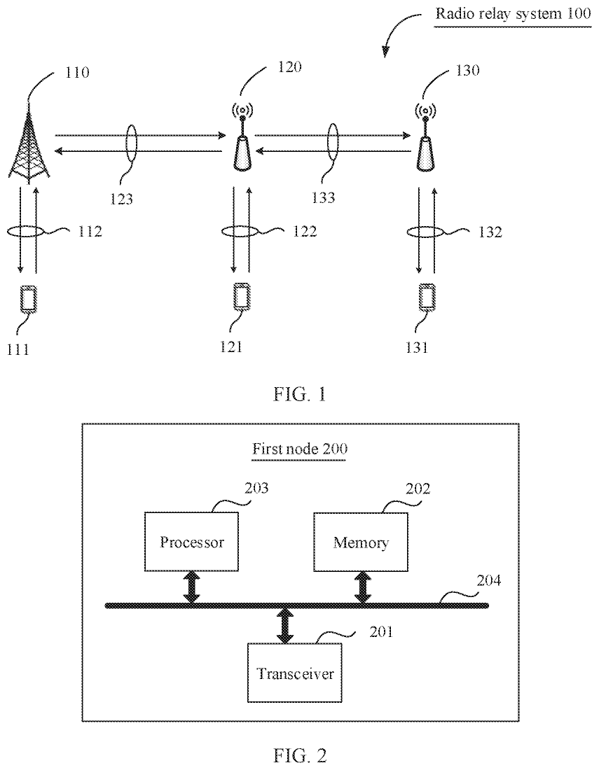

FIG. 1 is a radio relay system according to an embodiment of this application. It should be noted that, the radio relay system mentioned in the embodiments of this application includes but is not limited to: a narrowband Internet of Things (NB-IoT) system, a global system for mobile communications (GSM), an enhanced data rate for GSM evolution (EDGE, GSM) system, a wideband code division multiple access (WCDMA) system, a code division multiple access 2000 (CDMA 2000) system, and a time division-synchronization code division multiple access (TD-SCDMA) system, a long term evolution (LTE) system, a next-generation 5G mobile communications system (5th-generation), a machine-to-machine (M2M) system, and the like.

As shown in FIG. 1, a radio relay system 100 at least includes a base station 110, at least one UE 111 served by the base station 110, one or more relay nodes an rTRP 120 and an rTRP 130, one or more UEs 121 served by the rTRP 120, and one or more UEs 131 served by the rTRP 130. The rTRP 120 is connected to the base station 110 by using a wireless backhaul link 123, the rTRP 130 is connected to the rTRP 120 by using a wireless backhaul link 133, the UE 111 is connected to the base station 110 by using an access link 112, the UE 121 is connected to the rTRP 120 by using an access link 122, and the UE 131 is connected to the rTRP 130 by using an access link 132. In a next-generation radio air interface, the base station 110 is usually referred to as a DgNB (donor gNB). The base station 110 includes but is not limited to: an evolved NodeB (eNB), a radio network controller (RNC), a NodeB (NB), a base station controller (BSC), a base transceiver station (BTS), a home NodeB (HNB), a baseband unit (BBU), a next-generation new radio NR base station (such as a gNB), and the like.

In implementation, the base station 110 in the radio relay system shown in FIG. 1 may be used as a first node in this embodiment of this application, or the rTRP 120 may be used as a first node in this embodiment of this application. The rTRP 120 may use another device that has a relay function as a lower-level node, or the UE 121 accesses the rTRP 120. A second node may be a device that has the relay function in the lower-level node of the first node, for example, the rTRP 120 or the rTRP 130 shown in FIG. 1, in implementation, if the base station 110 is the first node, the (FRP 120 shown in FIG. 1 may be used as the second node in this embodiment of this application.

As shown in FIG, 2, a first node 200 in the embodiments of this application may include a transceiver 201, a memory 202, and a processor 203. The transceiver 201 is configured to interact with a second node 300, the memory 202 may be configured to store code that needs to be executed by the processor 203, and the processor 203 may be a general-purpose central processing unit (CPU), a microprocessor, an application-specific integrated circuit (ASIC), or one or more integrated circuits, and is configured to perform a related operation based on the code stored in the memory 202, to implement technical solutions provided in the embodiments of this application. In implementation, the transceiver 201, the memory 202, and the processor 203 may be connected to each other by using a bus structure 204.

As shown in FIG. 3, a second node 300 in the embodiments of this application includes a transceiver 301, a memory 302, and a processor 303. The transceiver 301 is configured to interact with a first node 200, the memory 302 may be configured to store code that needs to be executed by the processor 303, and the processor 303 may be a general-purpose central processing unit, a microprocessor, an application-specific integrated circuit, or one or more integrated circuits, and is configured to perform a related operation based on the code stored in the memory 302, to implement technical solutions provided in the embodiments of this application. In implementation, the transceiver 301, the memory 302, and the processor 303 may be connected to each other by using a bus structure 304.

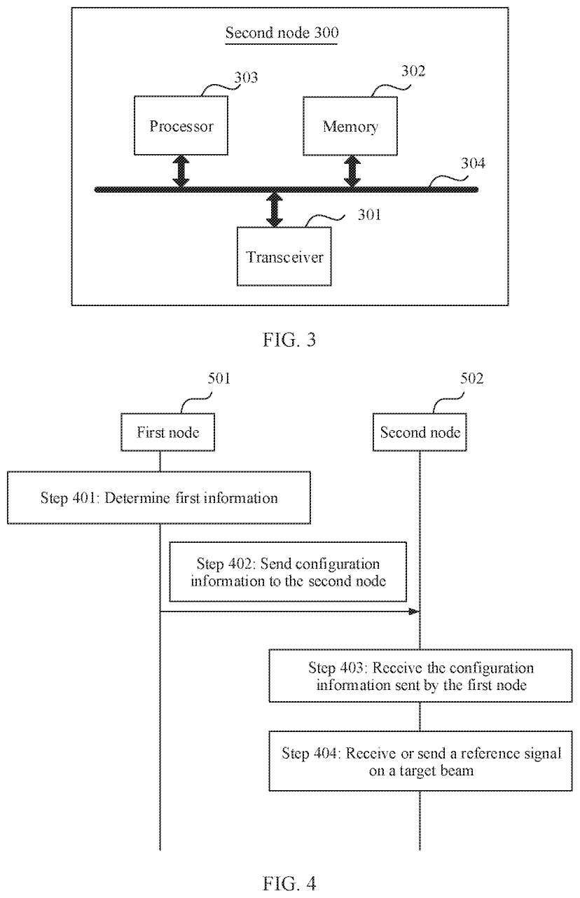

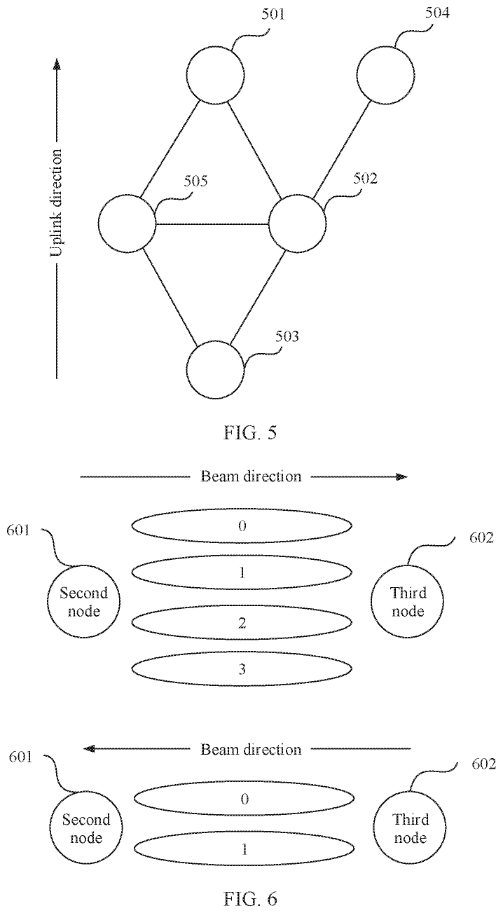

FIG. 4 is a schematic diagram of steps of a method for configuring a reference signal according to an embodiment of the present invention. In the method, a first node and a second node implement configuration of a reference signal. As shown in FIG. 5, a first node 501 may be an upper-level node of a second node 502 in a wireless communications system, and the wireless communications system shown in FIG. 5 further includes a third node 503. Specifically, the method includes the following steps:

S401: The first node determines first information, where the first information includes beam information of beams used by a link between the second node and the third node.

S402: The first node sends configuration information to the second node, where the configuration information is used to indicate configuration information of a reference signal received or sent by the second node on a target beam, and the target beam is at least one of the beams used by the link between the second node and the third node.

S403: The second node receives the configuration information sent by the first node.

S404: The second node receives or sends the reference signal on the target beam.

According to the foregoing steps, the first node can configure, based on the determined first information, the second node to receive or send the reference signal on the target beam, where the target beam is at least one of the beams that are indicated by the first information and that are used by the link between the second node and the third node. Therefore, according to the solution, the first node in the wireless communications system can configure the second node, namely, a lower-level relay node, to receive or send the reference signal on a beam between the second node and another relay node, so that the second node can perform interference measurement based on the received or sent reference signal, and a relay node can perform the interference measurement between backhaul links.

It should be noted that, in this application, that the reference signal is sent by the second node to the third node, or the reference signal is sent by the third node to the second node is not limited, but the second node is only required to receive or send the reference signal by using the target beam. For example, the reference signal received by the second node may be sent by a fourth node.

It should be noted that in this embodiment of this application, the third node is not limited to be a lower-level node of the second node. The third node in this embodiment may be set based on a requirement for sending the reference signal. For example, as shown in FIG. 5, when the first node 501 needs to measure interference between the second node 502 and a lower-level node 503 of the second node by configuring the reference signal, the lower-level node 503 may be used as the third node in this embodiment of this application. When the first node 501 needs to measure interference between the second node 502 and an upper-level node 504 by configuring the reference signal, the upper-level node 504 may be used as the third node in this embodiment of this application. In addition, another lower-level node 505 that is of the first node and that connects to the second node 502 via a backhaul link may also be used as the third node based on a requirement.

In step 401, the beams used by the link between the second node and the third node may be transmit beams used by the second node to send information to the third node, so that the first information determined by the first node may include beam information of the transmit beams used by the second node to send the information to the third node; or the beams used by the link between the second node and the third node may be receive beams used by the second node to receive information sent by the third node, so that the first information determined by the first node may include beam information of the receive beams used by the second node to receive the information sent by the third node.

In implementation, after receiving the configuration information, the second node may send the configuration information to the third node, so that the third node receives the reference signal based on the configuration information, or the third node sends the reference signal based on the configuration information. For example, if the first information is information about the receive beams used by the second node to receive the information sent by the third node, the configuration information sent by the first node to the second node may be used to indicate the reference signal received by the second node on the target beam, where the target beam is at least one of the receive beams used by the second node to receive the information sent by the third node. The second node may send the configuration information to the third node after receiving the second configuration information, so that the third node sends the reference signal to the second node based on the configuration information.

In an implementation, the first node determines, based on the first information, the configuration information sent to the second node in step 402. Specifically, the first node may determine, based on the beam information that is included in the first information and that is of the beams used by the link between the second node and the third node, the beams used by the link between the second node and the third node, use at least one of the determined beams as the target beam, and generate the configuration information used to indicate the second node to receive or send the reference signal on the target beam.

In an implementation, the beam information of the beams used by the link between the second node and the third node may be at least one piece of the following information: a beam number, an identifier of a sending node of one of the beams, an identifier of a receiving node of one of the beams, a beam index, or a quantity of the beams used by the link between the second node and the third node.

In implementation, the beam number may be information about numbers used to identify the transmit beams or the receive beams. For example, the second node sorts and numbers all the transmit beams pointed by the second node to the third node in advance, so that the transmit beams can be uniquely identified only based on the beam numbers. If the first information determined by the first node includes the numbers of the transmit beams used by the second node to send information to the third node, the first node may add one or more beam numbers to the configuration information, so that the second node can use a beam to which the beam number in the configuration information belongs as the target beam, to implement the indication of the target beam.

As shown in FIG. 6, if first information determined by a first node includes that beam numbers of a plurality of transmit beams used by a second node 601 to send information to a third node 602 are respectively 0, 1, 2, and 3, the first node may add a beam number 3 to the configuration information, and the configuration information is used to indicate the second node to send the reference signal by using a beam of which the beam number is 3 as the target beam.

In implementation, the beam information of the beams used by the link between the second node and the third node may further include information about a sending node and/or a receiving node of one of the beams. If the beam is a transmit beam used for sending information, an identifier of the sending node of the beam may be an identifier of a node that sends information by using the transmit beam, and an identifier of the receiving node of the beam may be anode that receives the information. If the beam is a receive beam, the receiving node of the beam may be a node that receives information by using the receive beam, and the sending node of the beam may be a node that sends the information. The identifier of the node may be an identifier (ID) of the node, the node ID may be an inherent ID of the node or an ID allocated by a network to the node, and the node ID includes but is not limited to a physical cell ID, a radio network temporary identifier (RNTI), and the like. The first node may determine, based on the information about the sending node of the beam and/or the receiving node of the beam, the backhaul link to which the beam belongs, and determine whether the beam is a transmit beam of the second node or a receive beam of the second node. In this way, the sending node and/or the receiving node of the beam may be pertinently indicated to pertinently measure interference of the backhaul link by receiving or sending the reference signal by the beam.

FIG. 6 is still used as an example. If first information determined by a first node further includes that beam numbers of a plurality of receive beams used by a second node 601 to receive information sent by a third node 602 are respectively 0 and 1, the first node may add, to the configuration information, a beam number 0, information indicating that a sending node of a beam is the second node 601, and information indicating that a receiving node of the beam is the third node 602, so that after receiving the configuration information, the second node 601 can use a transmit beam of which the number is 0 and that is used by the second node 601 to send information to the third node 602 as a target beam, to send the reference signal.

In implementation, after the first node determines that the beam numbers of the plurality of transmit beams used by the second node 601 to send the information to the third node 602 are respectively 0,1, 2, and 3, and the beam numbers of the plurality of receive beams used by the second node 601 to receive the information sent by the third node 602, a correspondence table, shown in Table 1, between a beam number and a sending node of a beam and a receiving node of a beam may be determined.

TABLE 1

| Beam number | Sending node of a beam | Receiving node of a beam |
|---|---|---|
| 0 | Second node | Third node |
| 1 | Second node | Third node |
| 2 | Second node | Third node |
| 3 | Second node | Third node |
| 0 | Third node | Second node |
| 1 | Third node | Second node |

According to Table 1, if the first node needs to indicate the second node to send the reference signal to the third node based on the beam of which the beam number is 1, the first node may add, to the configuration information, the beam number 1, the information indicating that the sending node of the beam is the second node, and the information indicating that the receiving node of the beam is the third node.

The beam information of the beams used by the link between the second node and the third node may further include a beam index. The beam index may be beam indexes of all beams between the second node and the third node, and can be used to uniquely identify all beams between the second node and the third node. In specific implementation, the beam index may be a number, or may be other identification information that can uniquely identify the beam.

In implementation, a correspondence between a beam index and a sending node of a beam, a receiving node of a beam, and the beam number may be stored in the first node and the second node. For example, the second node determines the foregoing correspondence and sends the correspondence to the first node, or the first node determines the foregoing correspondence and delivers the correspondence to the second node. In this case, after determining the first information, the first node may add a beam index of the target beam to the configuration information. After knowing the foregoing correspondence, the second node may determine, based on the foregoing correspondence, the sending node, the receiving node, and the beam number that are of the target beam and that correspond to the beam index, and then receive or send the reference signal by using the determined target beam.

FIG. 6 is still used as an example. After the first node determines that the beam numbers of the plurality of transmit beams used by the second node 601 to send the information to the third node 602 are respectively 0, 1, 2, and 3, and the beam numbers of the plurality of receive beams used by the second node 601 to receive the information sent by the third node 602, a beam index table shown in Table 2 may be formulated, and is used to store the correspondence table between the beam index and the sending node of the beam, the receiving node of the beam, and the beam number.

TABLE 2

| | | Sending node | Receiving node |
|---|---|---|---|
| Beam index | Beam number | of a beam | of a beam |
| 0 | 0 | Second node | Third node |
| 1 | 1 | Second node | Third node |
| 2 | 2 | Second node | Third node |
| 3 | 3 | Second node | Third node |
| 4 | 0 | Third node | Second node |
| 5 | 1 | Third node | Second node |

According to Table 2, if the first node needs to indicate the second node to send the reference signal to the third node based on the beam of which the beam number is 1, the first node may add the beam index I to the configuration information. When Table 2 is known, the second node may determine the target beam based on the beam index 1 in the configuration information.

The beam information of the beams used by the link between the second node and the third node may further include a quantity of the beams used by the link between the second node and the third node. The quantity of the beams used by the link between the second node and the third node may be a quantity of transmit beams used by the second node to send information to the third node, and/or a quantity of receive beams used by the second node to receive information sent by the third node. Alternatively, the beam information may include a quantity of transmit beams used by the third node to send information to the second node, and/or a quantity of receive beams used by the third node to receive information sent by the second node. If both the first node and the second node number the beams based on a same numbering rule, for example, based on a protocol definition or a signaling interaction rule, the sending node numbers the transmit beams from zero, and the receiving node numbers the receive beams from zero, the first node and the second node can obtain a same quantity of beam numbers based on a same quantity of beams. Therefore, the first node only needs to add, to the configuration information, a beam number obtained based on the foregoing numbering rule, and the second node can implement configuration of the reference signal by using a beam corresponding to the beam number as the target beam, so that the first node only needs to know the beam number, and does not need to know the beam corresponding to the beam number. Provided that the second node knows the beam corresponding to the beam number, the configuration of receiving or sending the reference signal can be implemented. When the third node needs to be configured to send or receive the reference signal in a direction of the beams of the link between the second node and the third node, the configuration information may be sent by the first node to the second node, and forwarded by the second node to the third node.

For example, if the first node determines that a quantity of transmit beams used by the second node to send information to the third node is 4, the second node separately numbers the transmit beams from 0 to 3 based on the numbering rule. In addition, when the first node knows that beam numbers of the transmit beams include transmit beams 0 to 3, the first node may add the beam number of the target beam to the configuration information. In this case, even if the beam information determined by the first node does not include the correspondence between a beam number and a beam, in other words, the first node actually cannot determine which transmit beam is specifically the transmit beam numbered 0, and only knows that the transmit beams used by the second node to send the information to the third node includes the transmit beam numbered 0. The second node can still determine, based on the existing numbering rule, a beam to which the transmit beam numbered 0 in the configuration information belongs, so that the transmit beam numbered 0 is used as the target beam used for sending the reference signal.

In a possible implementation, the beam information of the beams in this application may further include antenna port information, transport layer information, and data stream information. For example, the first information may include antenna port information of the link between the second node and the third node.

In a feasible implementation, the first information determined by the first node in step 401 may further include information indicating that there is a quasi co-location QCL relationship between the reference signal received or sent by the second node on the target beam and a reference signal of at least one beam, for example, if the first information includes an identifier and/or configuration information of a configured reference signal of the second node, after the foregoing configuration information is determined, the configuration information sent by the first node to the second node is used to indicate that there is a QCL relationship between the reference signal received or sent by the second node on the target beam and the configured reference signal. Therefore, after receiving the configuration information, the second node may receive or send the reference signal on the target beam that has a QCL relationship with the configured reference signal.

Specifically, the first information may further include information about the reference signal of the at least one beam known to the second node. The reference signal is used for transmission between the second node and the third node, or the reference signal has a QCL relationship with a remaining signal transmitted by the second node and the third node. First, transmission from the second node to the third node is considered. For example, a beam used to send a CSI-RS reference signal is configured between the second node and the third node, and the CSI-RS reference signal is denoted as CSI-RS_n1. After the second node reports the reference signal to the first node, and when configuring sending of the reference signal, the first node may indicate that the configured reference signal has a QCL relationship with the CSI-RS_n1. After receiving the foregoing configuration, the second node sends, by using a direction of a beam for sending the CSI-RS_n1, the reference signal configured by the first node. When configuring receiving of the reference signal, the first node may indicate that a new configured reference signal has a QCL relationship with the CSI-RS_n1. After receiving the foregoing configuration, the third node receives, by using a direction of a beam for receiving the CSI-RS_n1, the reference signal configured by the first node, and the reference signal may be sent by the fourth node. In addition, transmission from the third node to the second node is considered. In this case, the transmit beams may be determined by using a reference signal SRS of the third node, or may be determined by using a reference signal such as a synchronization signal block (SSB) of the second node, for example, SRS_m1 and SSB_l1. After the second node reports the reference signal (the SRS_m1 or the SSB_l1), when configuring sending of the reference signal, the first node may indicate that the configured reference signal has a QCL relationship with the SRS_m1 or the SSB_l1. In this case, the third node sends, in a direction of sending the SRS_m1 or a direction of receiving the SSB_l1, the reference signal configured by the first node. When configuring receiving of the reference signal, the first node may indicate that the configured reference signal has a QCL relationship with the SRS_m1 or the SSB_l1. In this case, the second node receives, in a direction of receiving the SRS_ m1 or in a direction of sending the SSB_l1, the reference signal configured by the first node. In the foregoing examples, the configuration of the third node performed by the first node may be forwarded by the second node to the third node.

In the following table, an identifier of a reference signal is merely used as an example. In practice, the reference signal may be identified by using information such as an SSB/PBCH block index, a CSI-RS resource number, an SRS resource number, and an antenna port number of the reference signal. In addition, a sending node and/or a receiving node of the reference signal may further need to be indicated.

TABLE 3

| | | Identifier of a |
|---|---|---|
| Sending node of a beam | Receiving node of a beam | reference signal |
| Second node | Third node | SSB_k1 |
| Second node | Third node | SSB_k2 |
| Second node | Third node | CSI-RS_n1 |
| Second node | Third node | CSI-RS_n1 |
| Third node | Second node | SRS_m1 |
| Third node | Second node | SSB_l1 |

According to Table 3, the first node may add an identifier (for example, the SSB_k2) of a known signal to the configuration information, and indicate that the reference signal sent by the second node has a QCL relationship with the SSB_k2. In this case, the second node sends the reference signal by using a beam for sending the SSB_k2.

In addition, according to Table 3, the first node may add the identifier SSB_l1 of the reference signal to the configuration information, to indicate the second node to receive the reference signal on the target beam. In this case, the direction of the beam for receiving the reference signal by the second node is the same as the direction of the beam for sending the SSB_l1 by the second node, that is, the SSB_l1 and the reference signal identified as SSB_l1 has a QCL relationship.

In addition, after determining information about the reference signal of at least one of the beams used by the link between the second node and the third node, the first node may further determine a correspondence table of a beam index and a configured reference signal, a sending node of a beam, a receiving node of a beam, and a beam number.

in a feasible implementation, the first information determined by the first node in step 401 may be reported by the second node.

in implementation, the step of reporting the first information by the second node may be triggered by the first node. For example, the first node may send the first message to the second node, and after receiving the first message, the second node uses beam information of at least one beam between the second node and the third node as the first information and reports the beam information to the first node. After receiving the first message, the second node may further report, to the first node, beam information of beams used by a link between the second node and all other nodes.

In addition, in implementation, after the beam information of the beams used by the link between the second node and the third node changes, the second node may report, to the first node, the beam information that changes and that is of the beams, or after the beam information of the beams used by the link between the second node and the third node changes, the second node reports, to the first node, changed beam information of the beams used by the link between the second node and the third node. For example, after numbers of the beams used by the link between the second node and the third node change, the second node may report the first information to the first node.

In another feasible implementation, the first information in step 401 may be determined by the first node in a pre-configuration manner. For example, beam information of some or all beams between the second node and the third node is pre-configured to the first node; or beam information of some or all beams between the second node and all other neighboring nodes may be configured to the first node, so that the first node may determine the first information based on pre-configuration.

In step 402, the configuration information sent by the first node to the second node may be further used to enable the second node to send an indicated reference signal. The reference signal may be a reference signal that is defined in an NR, for example, a reference signal such as the CSI-RS or the SRS, or may be a newly defined reference signal.

When configuring the second node or the third node to receive the reference signal, the first node may configure the second node or the third node to measure a reference signal receiving power (RSRP) of the reference signal, or may use the reference signal as an NZP-CSI-RS for interference measurement or a ZP-CSI-RS for interference measurement, measurement of receiving the reference signal is not specifically limited in this application. When a node is configured to measure the RSRP of the reference signal, a result obtained through measurement may be reported to the first node. When the reference signal is configured as the NZP-CSI-RS for the interference measurement or the ZP-CSI-RS for the interference measurement, the first node may simultaneously notify configuration information such as a time-frequency resource of an interference signal corresponding to the reference signal, and the second node or the third node may calculate information such as a signal to interference plus noise ratio (SINR)/channel quality indicator (CQI) based on the reference signal, where the information may be reported to the first node, or may not be reported.

FIG. 6 is used as an example to describe an implementation of a method for configuring a reference signal provided in an embodiment of the present invention with reference to Embodiment 1, Embodiment 2, and Embodiment 3.

### Embodiment 1

As shown in FIG. 6, a correspondence between a beam number determined by the second node 601 and a sending node of a beam and a receiving node of a beam is shown in Table 1. The second node 601 uses Table 1 as the first information and reports the first information to the first node. After receiving the first information, the first node determines a correspondence between a beam index and a beam number, a sending node of a beam, and a receiving node of a beam, to obtain the correspondence table shown in Table 2, and the correspondence table is used to determine the configuration information. The first node may send Table 2 to the second node 601. If the first node needs to indicate the second node 601 to send the CSI-RS by using the transmit beam of which the beam number is 3, the first node may add the beam index 3 to the configuration information, and the second node 601 can determine, based on Table 2 and the beam index in the configuration information, that the target beam indicated by the configuration information is the transmit beam of which the beam number is 3 and that is used by the second node 601 to send the information to the third node 602, so that the second node 601 may use the transmit beam as the target beam to send the CSI-RS.

### Embodiment 2

As shown in FIG. 6, a correspondence between a beam number determined by the second node 601 and a sending node of a beam and a receiving node of a beam is shown in Table 1. The second node 601 reports the first information to the first node. If the first node knows the numbering rule of the beam of the second node 601, the first information may be information indicating that a quantity of transmit beams used by the second node 601 to send the information to the third node 602 is 4, and information indicating that a quantity of receive beams used by the second node 601 to receive the information sent by the third node 602 is 2. Therefore, the first node can determine, based on the numbering rule that is of the beam of the second node 601 and that is known to the first node, that beam numbers of the transmit beams used by the second node 601 to send the information to the third node 602 are 0 to 3, and the first node can determine that beam numbers of the receive beams used by the second node 601 to receive the information sent by the third node 602 are 0 and 1. Then, the first node may add, to the configuration information, the beam number 3, information indicating that the sending node of the beam is the second node 601, and information indicating that the receiving node of the beam is the third node 602, to indicate the second node 601 to send the CSI-RS by using the beam of which the beam number is 0. After receiving the configuration information, the second node 601 may send the CSI-RS based on the beam of which the beam number is 3 in Table 1.

### Embodiment 3

As shown in FIG. 6, a correspondence between a beam number of the second node 601, a sending node of a beam, a receiving node of a beam, and an identifier of a configured reference signal is shown in Table 4. The second node 601 may use the correspondence shown in Table 3 as the first information and report the first information to the first node.

TABLE 4

| | Sending node | Receiving node | Identifier of a |
|---|---|---|---|
| Beam number | of a beam | of a beam | reference signal |
| 0 | Second node | Third node | SSB_k1 |
| 1 | Second node | Third node | SSB_k2 |
| 2 | Second node | Third node | CSI-RS_n1 |
| 3 | Second node | Third node | CSI-RS_n1 |
| 0 | Third node | Second node | SRS_m1 |
| 1 | Third node | Second node | SSB_l1 |

If the first node needs to indicate the second node 601 to send the CSI-RS to the third node 602 by using the transmit beam of which the beam number is 3, the first node may add the identifier CSI-RS_n1 of the reference signal to the configuration information, and may further add information indicating that the second node 601 is the sending node and information indicating that the second node 602 is the receiving node. In this case, after receiving the configuration information, the second node 601 sends the CSI-RS that has a QCL relationship with the CSI-RS_n1 reference signal.

Based on a concept the same as that of the foregoing method embodiments, an embodiment of this application further provides a first node for configuring a reference signal. The first node includes a transceiver, a memory, and a processor, to complete the method related to the first node in the foregoing method embodiments or any one of possible implementations of the method embodiments.

In the embodiments of this application, the first node may be divided into function modules based on the foregoing method examples. For example, function modules may be divided by using corresponding functions, or two or more functions may be integrated into one processing module. The foregoing integrated module may be implemented in a form of hardware, or may be implemented in a form of a software function module. It should be noted that, in the embodiments of this application, module division is merely an example, and is merely a logical function division. In an actual implementation, another division manner may be used.

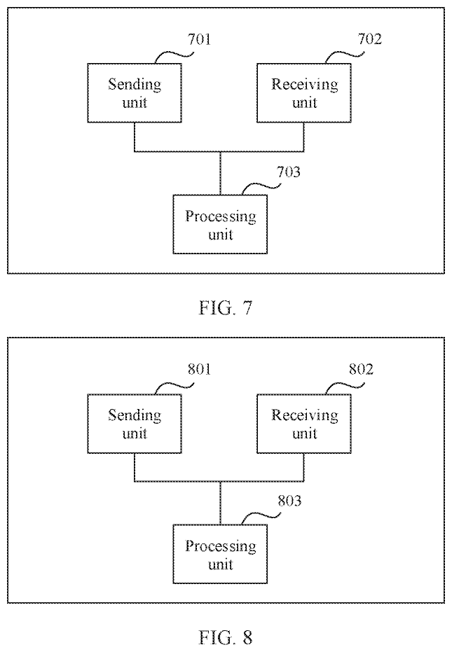

When the function modules is divided by using corresponding functions, FIG. 7 is a possible schematic structural diagram of a first node in the foregoing embodiments. The first node includes a sending unit 701 and a receiving unit 702. The sending unit 701 is configured to support the first node in performing the step of sending information by the first node device in this embodiment. The receiving unit 702 is configured to support the first node in performing the step of receiving information by the first node device in this embodiment. Optionally, the first node further includes a processing unit 703, configured to support the first node in performing the step of determining information by the first node in Embodiment 1, another function other than functions of the sending unit 701 and the receiving unit 702, and the like.

In hardware implementation, the foregoing processing unit 703 may be a processor, a processing circuit, or the like. The sending unit 701 may be a transmitter, a transmitter circuit, or the like. The receiving unit 702 may be a receiver, a receiver circuit, or the like. The sending unit 701 and the receiving unit 702 may form a transceiver.

FIG. 2 is a possible schematic diagram of a logical structure of a first node 200 in the foregoing embodiments according to an embodiment of this application. The first node 200 includes a processor 203. In this embodiment of this application, the processor 203 is configured to control and manage an action of the first node 200. For example, the processor 203 is configured to support a related step of determining first information by the first node 200 in this embodiment. Optionally, the first node 200 may further include a transceiver 201 and a memory 202. The transceiver 201, the memory 202, and the processor 203 may be connected to each other or may be connected to each other by using a bus structure 204. The memory 202 is configured to store code and data of the first node 200. The transceiver 201 is configured to support the first node 200 to perform communication.

In the first node shown in FIG. 2, the processor 203 may be a central processing unit, a general purpose processor, a digital signal processor, an application-specific integrated circuit, a field programmable gate array or another programmable logic device, a transistor logic device, a hardware component, or any combination thereof. The processor 203 may implement or execute various example logical blocks, modules, and circuits described with reference to content disclosed in this application. Alternatively, the processor 203 may be a combination of processors implementing a computing function, for example, a combination of one or more microprocessors, or a combination of a digital signal processor and a microprocessor.

Based on a concept the same as that of the foregoing method embodiments, an embodiment of this application further provides a second node for configuring a reference signal. The second node includes a transceiver, a memory, and a processor, to complete the method related to the second node in the foregoing method embodiments or any one of possible implementations of the method embodiments.

In the embodiments of this application, the second node may be divided into function modules based on the foregoing method examples. For example, function modules may be divided by using corresponding functions, or two or more functions may be integrated into one processing module. The foregoing integrated module may be implemented in a form of hardware, or may be implemented in a form of a software function module. It should be noted that, in the embodiments of this application, module division is merely an example, and is merely a logical function division. In an actual implementation, another division manner may be used.

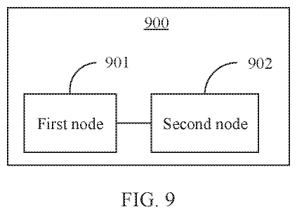

When the function modules is divided by using corresponding functions, FIG. 8 is a possible schematic structural diagram of a second node in the foregoing embodiments. The second node includes a sending unit 801 and a receiving unit 802. The sending unit 801 is configured to support the second node in performing the step of sending information by the second node device in this embodiment. The receiving unit 802 is configured to support the second node in performing the step of receiving information by the second node device in this embodiment. Optionally, the second node further includes a processing unit 803, configured to support the second node in performing the step of determining information by the second node in Embodiment 1, for example, determining a target beam, another function other than functions of the sending unit 801 and the receiving unit 802, and the like.

In hardware implementation, the foregoing processing unit 803 may be a processor, a processing circuit, or the like. The sending unit 801 may be a transmitter, a transmitter circuit, or the like. The receiving unit 802 may be a receiver, a receiver circuit, or the like. The sending unit 801 and the receiving unit 802 may form a transceiver.

FIG. 3 is a possible schematic diagram of a logical structure of a second node 300 in the foregoing embodiments according to an embodiment of this application. The second node 300 includes a processor 303. In this embodiment of this application, the processor 303 is configured to control and manage an action of the second node 300. Optionally, the second node 300 may further include a transceiver 301 and a memory 302. The transceiver 301, the memory 302, and the processor 303 may be connected to each other or may be connected to each other by using a bus structure 304. The memory 302 is configured to store code and data of the second node 300. The transceiver 301 is configured to support the second node 300 to perform communication.

In the second node shown in FIG. 3, the processor 303 may be a central processing unit, a general purpose processor, a digital signal processor, an application-specific integrated circuit, a field programmable gate array or another programmable logic device, a transistor logic device, a hardware component, or any combination thereof. The processor 303 may implement or execute various example logical blocks, modules, and circuits described with reference to content disclosed in this application. Alternatively, the processor 303 may be a combination of processors implementing a computing function, for example, a combination of one or more microprocessors, or a combination of a digital signal processor and a microprocessor.

Based on a concept the same as that of the foregoing method embodiments, an embodiment of this application further provides a system for configuring a reference signal. The system includes a first node and a second node, to complete the method in the foregoing method embodiments or any one of possible implementations of the method embodiments.

As shown in FIG. 9, an embodiment of this application further provides a system 900 for configuring a reference signal. The system 900 includes a first node 901 and a second node 902, where the first node 901 may include the structure shown in FIG. 2 or FIG. 7, and the second node 902 may include the structure shown in FIG. 3 or FIG. 8.

Based on a same concept as the foregoing method embodiments, an embodiment of this application further provides a computer-readable storage medium. The computer-readable storage medium stores code, and when the code is invoked and executed by a computer, the computer may be enabled to complete the method for configuring the reference signal related to the first node in the foregoing method embodiments or any one of possible implementations of the method embodiments. In the embodiments of this application, the computer-readable storage medium is not limited. For example, the computer-readable storage medium may be a RAM (random-access memory), a ROM (read-only memory), or the like.

Based on a concept the same as that of the foregoing method embodiments, an embodiment of this application further provides another computer-readable storage medium. The computer-readable storage medium stores code, and when the code is invoked and executed by a computer, the computer may be enabled to complete the method for configuring the reference signal related to the second node in the foregoing method embodiments or any one of possible implementations of the method embodiments. In the embodiments of this application, the computer-readable storage medium is not limited, for example, the computer-readable storage medium may be a RAM, a ROM, or the like.

Based on a concept the same as that of the foregoing method embodiments, this application further provides a computer program product. When the computer program product is invoked and executed by a computer, the computer may be enabled to complete the method related to the first node in the foregoing method embodiments or any one of possible implementations of the method embodiments.

Based on a concept the same as that of the foregoing method embodiments, this application further provides a computer program product. When the computer program product is invoked and executed by a computer, the computer may be enabled to complete the method related to the second node in the foregoing method embodiments or any one of possible implementations of the method embodiments.

Based on a concept the same as that of the foregoing method embodiments, this application further provides a chip. The chip is coupled to a transceiver, and is configured to complete the method related to the first node in the foregoing method embodiments or any one of possible implementations of the method embodiments. “Coupling” means that two components are directly or indirectly combined with each other, the combination may be fixed or movable, and the combination may allow communication of a fluid, electricity, an electrical signal, or another type of signal between the two components.

Based on a concept the same as that of the foregoing method embodiments, this application further provides a chip. The chip is coupled to a transceiver, and is configured to complete the method related to the second node in the foregoing method embodiments or any one of possible implementations of the method embodiments.

Persons skilled in the art should understand that the embodiments of this application may be provided as a method, a system, or a computer program product. Therefore, this application may use a form of a hardware-only embodiment, a software-only embodiment, or an embodiment with a combination of software and hardware. In addition, this application may use a form of a computer program product implemented on one or more computer-usable storage media (including but not limited to a magnetic disk memory, a CD-ROM (read only optical disk), an optical memory, and the like) that include computer-usable program code.

This application is described with reference to the flowcharts and/or block diagrams of the method, the device (system), and the computer program product according to the embodiments of this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of any other programmable data processing device to generate a machine, so that the instructions executed by the computer or the processor of any other programmable data processing device generate an apparatus for implementing a specific function in one or more processes in the flowcharts and/or in one or more blocks in the block diagrams.

The computer program instructions may alternatively be stored in a computer-readable memory that can instruct a computer or another programmable data processing device to work in a specific manner, so that the instructions stored in the computer-readable memory generate an artifact including an instruction apparatus. The instruction apparatus implements a specific function in one or more processes in the flowcharts and/or in one or more blocks in the block diagrams.

The computer program instructions may alternatively be loaded onto a computer or another programmable data processing device, so that a series of operations and steps are performed on the computer or the another programmable device, to generate computer-implemented processing. Therefore, the instructions executed on the computer or another programmable device provide steps for implementing a specific function in one or more processes in the flowcharts and/or in one or more blocks in the block diagrams.

Although some possible embodiments of this application is described, persons skilled in the art can make changes and modifications to the embodiments once the basic inventive concept is learnt. Therefore, the following claims are intended to be construed to cover the embodiments of this application and all changes and modifications falling within the scope of this application.

Apparently, persons skilled in the art can make various modifications and variations to this application without departing from the spirit and scope of this application. This application is intended to cover the modifications and variations of this application provided that they fall within the scope of the following claims and equivalent technologies of this application.

What is claimed is:

1. A method for configuring a reference signal, comprising:
determining, by a first node, first information, wherein the first information comprises beam information of beams used by a link between a second node and a third node, and wherein the first node is an upper-level node of the second node; and
sending, by the first node, configuration information to the second node, wherein the configuration information is used to indicate configuration information of a reference signal received or sent by the second node on a target beam, and wherein the target beam is at least one of the beams used by the link between the second node and the third node.

2. The method according to claim 1, wherein the beams used by the link between the second node and the third node comprises:
a transmit beam used by the second node to send information to the third node, or a receive beam used by the second node to receive information sent by the third node.

3. The method according to claim 1, wherein the beam information of the beams used by the link between the second node and the third node comprises at least one piece of the following information:
a beam number;
an identifier of a sending node of one of the beams;
an identifier of a receiving node of one of the beams;
a beam index, wherein the beam index corresponds to the sending node of one of the beams, the receiving node of one of the beams, and the beam number; or
a quantity of the beams used by the link between the second node and the third node.

4. The method according to claim 1, wherein the first information further comprises information about a reference signal of at least one beam between the second node and the third node.

5. The method according to claim 1, wherein the configuration information of the reference signal received or sent by the second node on the target beam comprises:
information indicating that there is a quasi co-location (QCL) relationship between the reference signal received or sent by the second node on the target beam and the reference signal of the at least one beam.

6. A method for configuring a reference signal, comprising:
receiving, by a second node, configuration information sent by a first node, wherein the configuration information is used to indicate configuration information of a reference signal received or sent by the second node on a target beam, wherein the target beam is at least one of beams used by a link between the second node and a third node, and wherein the first node is an upper-level node of the second node; and
receiving or sending, by the second node, the reference signal on the target beam.

7. The method according to claim 6, further comprising:
sending, by the second node, first information to the first node, wherein the first information comprises beam information of the beams used by the link between the second node and the third node.

8. The method according to claim 6, wherein the beams used by the link between the second node and the third node comprises:
a transmit beam used by the second node to send information to the third node, or a receive beam used by the second node to receive information sent by the third node.

9. The method according to claim 6, wherein beam information of the beams used by the link between the second node and the third node comprises at least one piece of the following information:
information about a beam number;
an identifier of a sending node of one of the beams;
an identifier of a receiving node of one of the beams;
a beam index, wherein the beam index corresponds to the sending node of one of the beams, the receiving node of one of the beams, and the beam number; or
a quantity of the beams used by the link between the second node and the third node.

10. The method according to claim 6, wherein the first information further comprises information about a reference signal of at least one beam between the second node and the third node.

11. The method according to claim 7, wherein the configuration information of the reference signal received or sent by the second node on the target beam comprises:
information indicating that there is a quasi co-location (QCL) relationship between the reference signal received or sent by the second node on the target beam and the reference signal of the at least one beam; and
wherein the receiving or sending, by the second node, the reference signal on the target beam comprises:
receiving or sending, by the second node on the target beam, the reference signal that has the quasi co-location (QCL) relationship with the reference signal of the at least one beam.

12. A first node for configuring a reference signal, comprising: a transceiver, a memory, and at least one processor, wherein:
the transceiver is used by the first node to perform communication;
the memory is configured to store code; and
the code, when executed by the at least one processor, causes the first node to:
determine first information based on the code stored in the memory, and
control the transceiver to send configuration information to a second node, wherein the first information comprises beam information of beams used by a link between the second node and a third node, wherein the first node is an upper-level node of the second node, wherein the configuration information is used to indicate configuration information of a reference signal received or sent by the second node on a target beam, and wherein the target beam is at least one of the beams used by the link between the second node and the third node.

13. The first node according to claim 12, wherein the beams used by the link between the second node and the third node comprises:
a transmit beam used by the second node to send information to the third node, or
a receive beam used by the second node to receive information sent by the third node.

14. The first node according to claim 12, wherein the beam information of the beams used by the link between the second node and the third node comprises at least one piece of the following information:
a beam number;
an identifier of a sending node of one of the beams;
an identifier of a receiving node of one of the beams;
a beam index, wherein the beam index corresponds to the sending node of one of the beams, the receiving node of one of the beams, and the beam number; or
a quantity of the beams used by the link between the second node and the third node.

15. The first node according to claim 12, wherein the first information further comprises information about a reference signal of at least one beam between the second node and the third node.

16. The first node according to claim 12, wherein the configuration information of the reference signal received or sent by the second node on the target beam comprises:
information indicating that there is a quasi co-location (QCL) relationship between the reference signal received or sent by the second node on the target beam and the reference signal of the at least one beam.

17. A second node for configuring a reference signal, comprising: a transceiver, a memory, and at least one processor, wherein:
the transceiver is used by the second node to perform communication;
the memory is configured to store code; and
the code, when executed by the at least one processor, causes the second nodeto:
receive, by using the transceiver, configuration information sent by a first node; and
control the transceiver to receive or send the reference signal on a target beam, wherein the configuration information is used to indicate configuration information of the reference signal received or sent by the second node on the target beam, wherein the target beam is at least one of beams used by a link between the second node and a third node, and wherein the first node is an upper-level node of the second node.

18. The second node according to claim 17, wherein the code causes the first node further to:
control the transceiver to send first information to the first node, wherein the first information comprises beam information of the beams used by the link between the second node and the third node.

19. The second node according to claim 17, wherein the beams used by the link between the second node and the third node comprises:
a transmit beam used by the second node to send information to the third node, or
a receive beam used by the second node to receive information sent by the third node.

20. The second node according to claim 17, wherein the beam information of the beams used by the link between the second node and the third node comprises at least one piece of the following information:
information about a beam number;
an identifier of a sending node of one of the beams;
an identifier of a receiving node of one of the beams;
a beam index, wherein the beam index corresponds to the sending node of one of the beams, the receiving node of one of the beams, and the beam number; or
a quantity of the beams used by the link between the second node and the third node.
